(19) United States
(12) Patent Application Publication
(10) Pub. No.: US 2015/0174718 A1
(43) Pub. Date: Jun. 25, 2015

(54) Tool for Machining a Workpiece, Production Line Equipped with Such a Machine Tool, and Method for Operating Such a Production Line

(71) Applicant: Josef Preis, Amoeneburg-Mardorf (DE)

(72) Inventor: Josef Preis, Amoeneburg-Mardorf (DE)

(73) Assignee: Buderus Schleiftechnik GmbH, Asslar (DE)

(21) Appl. No.: 14/344,180

(22) PCT Filed: Sep. 12, 2012
(86) PCT No.: PCT/EP2012/067807

§ 371 Date: Mar. 11, 2015

(30) Foreign Application Priority Data
Sep. 12, 2011 (DE) 10 2011 053 538.1

(51) Int. Cl. B23Q 7/03; B23P 13/00

(52) U.S. Cl. CPC B23Q 7/03; B23P 13/00

(57) ABSTRACT

Disclosed is a machine tool for machining a workpiece which includes a machining cell with a machining device for machining the workpiece and a transfer point for transferring a workpiece to be machined to the machining device or for outputting a finish-machined workpiece from the machining device. In order permit a high flexibility in such a machine when used in a production line, the machine tool includes a conveying device which transports a workpiece transferred to it between at least two take-over positions, while bypassing the machining device.

The present invention relates to a machine tool for machining a workpiece, wherein the machine tool comprises a machining cell having a machining device for machining the respective workpiece and a transfer point for transferring a workpiece to be machined to the machining device or for outputting the finish-machined workpiece from the machining device. The invention also relates to a production line equipped with at least one such machine to and a method for its operation.

For mass production of complex shaped structural parts the respective workpiece as a rule passes through a relatively large number of machine tools, in which respectively a specific machining step is performed on the workpiece. In practice the machine tools are for this purpose combined to form so-called “production lines”, which in specialist terminology are also called “assembly lines”.

The workpieces fed into the production line pass in a specific conveying direction through the machine tools of the production line arranged after one another in a line. The feeding of the workpieces into the production line is performed as a rule by an automatic workpiece conveyor or from a workpiece store.

Such workpiece conveyors are as a rule conveyor belts or conveyor chains, which transport the workpieces along the machine tools and by means of which the machine tools of a production line are correspondingly linked via one another to the respective production run. The workpieces to be machined are removed from the workpiece conveyor at the respective station and are placed again the conveyor after completion of the machining.

A workpiece store on the other hand is as a rule a stationary container, in which the workpieces to be machined can be held in readiness and the finish-machined workpieces can be stored. Comparable workpiece storage and feed systems are also known from individually standing machine tools, in which the workpieces are arranged in specific pre-sorted groups, for example in bins, at a specific transfer position of the machine tool and from there are taken and fed piece by piece to the machine tool, in which the respective machining is then carried out. The transfer of the respective finish-machined workpiece takes place in a corresponding manner.

A typical example of the use of a production line of the type discussed here is the production of gearbox parts for vehicles. In such machine tools a large number of metal-cutting machining operations, such as for example milling, drilling, turning, grinding and honing operations, have to be performed in each case on such workpieces on the path from the blank to the finished gearbox part. Since these machining operations take place individually in an optimised sequence and are assigned to machine tools of the production line specialising in the respective operation, optimised results in terms of large batch quantities can be achieved in minimal throughput times.

The high specialisation of production lines of the type discussed above is offset by the low flexibility of such production systems. Thus, the machining operations performed in each case in the production line can be adapted only with great effort to new operating cycle demands. This is true in particular of those systems in which the feed and transfer of the workpieces is performed by an automation cell. Furthermore, especially in systems in which the workpiece transportation between the machine tools takes place via a jointly used, independently operating workpiece conveyor, high maintenance effort and spatial requirements are involved, which complicate the replacement of individual machine tools that may become necessary for example due to a defect.

Against the background of the prior art discussed above, the object of the invention was to provide a machine tool that when used in a production line of the type discussed above permits a high flexibility but at the same time can also be operated as an individual machine. In addition such a production line should be created in which an optimised flexibility is easily ensured and which is easy to maintain and service. A method for operating a corresponding production line should also be provided.

With respect to the machine tool this object is achieved according to the invention in that such a machine tool is designed according to claim 1.

The solution according to the invention of the object mentioned hereinbefore in relation to the production line is the fact that at least one device according to the invention is present in such a production line.

The method according to the invention for operating a production line according to the invention includes the operating steps disclosed in claim 15.

Advantageous modifications of the invention are disclosed in the dependent claims and like the general inventive concept are discussed hereinafter in detail.

A machine tool according to the invention for machining a workpiece accordingly comprises in agreement with the prior art mentioned in the introduction a machining cell, wherein this machining cell comprises a machining device for machining the respective workpiece and a transfer point for transferring a workpiece to be machined to the machining device or for outputting a finish-machined workpiece form the machining device. According to the invention the machine tool now additionally includes as an integral constituent a conveying device, which transports a workpiece transferred to it between at least two take-over positions, while bypassing the machining device.

The conveying device provided in a machine tool according to the invention forms a bypass, via which the workpieces can be diverted around the operating region of the machining device of the respective machine tool. If a machine tool according to the invention is used as part of a production line in which several machine tools designed in the manner according to the invention are coupled to one another, an individual machine tool can be bypassed in this way so that the workpiece is guided by the respective conveying device of the relevant machine tool to the next machine tool of the production line.

A decisive requirement for this is that the conveying device is an integral constituent of the machine tool according to the invention. In other words, the conveying device is coupled structurally as well as functionally directly to the machine tool. The conveying device of a machine tool according to the invention is not as such a separate structural unit that can operate independently of the machine tool, but as an essential functional constituent in a machine tool according to the invention basically expands its mode of operation.

Thus, a finish-machined workpiece in the processing cell of a machine tool according to the invention can on account of the conveying device provided according to the invention be transported from the respective machine tool itself to the next machining station. In exactly the same way the conveying device of a machine tool according to the invention can be used to transport a workpiece that had previously been machined in another machine from this machine, so as then to machine it further in the machine tool according to the invention.

For this purpose the workpiece does not have to be removed from the production line, nor does the workpiece flow within the production line have to be changed. Instead, in cases in which a machining is to be carried out on certain workpieces and not on others, but afterwards the workpieces should be reunited, the transportation of the workpieces effected via the conveying device can take place in the same cycle as a machining within the machine tool. It is also possible to couple together several machine tools according to the invention provided for the same machining, in which workpieces are machined in the same way parallel to one another. If in this case a machine tool is occupied, then the respective workpiece to be machined can be conveyed to the next machine tool.

In contrast to production lines in which the workpieces are brought from workstation to workstation via a separate, independently operating workpieces conveyor in a conveying direction that is fixed to start with and cannot subsequently be changed, the conveying device assigned according to the invention to the respective machine tool itself enables the direction with which the workpieces are conveyed from the conveying device through the relevant machine tool to be chosen in each case individually and independently of a fixed procedure. Thus, with a machine tool according to the invention the conveying device can be used in the same way in order to take workpieces from the machine tool or convey workpieces to the machine tool. In this way with the aid of machine tools according to the invention widely different production runs can be accomplished without major effort in a production line, for which in conventional production lines intended respectively only for one conveying direction, in each case relatively major readjustments of the order of the machining tools and correspondingly major conversion work would be necessary.

As a result, with a machine tool according to the invention and in a production line equipped according to the invention, not only can the overall machining time be significantly reduced, but also the flexibility and associated therewith the versatility of its possible uses can also be significantly improved.

A further important advantage of an independent machine tool as a structural unit provided with a conveying device according to the invention is that such a machine per se can be incorporated without any problem into a production line. Likewise, it can however also be operated as a free-standing machine. A machine tool configured according to the invention can therefore be used flexibly to a large degree.

This flexibility proves advantageous particularly if in a production line according to the invention a machine tool according to the invention has to be replaced for maintenance purposes. Thus, such a machine tool can be replaced without any problem by another similar machine. Since the machine tools according to the invention with their conveying devices form in each case compactly related structural units, for this purpose simply the machine to be serviced has to be removed from the production line and replaced by a similar machine. The latter can for example previously have been operating alone at another site. Complicated conversion measures are not required for such an exchange, since the conveying device provided according to the invention can then be integrated into a machine tool itself operating in stand-alone mode if it is not used in this type of operation.

The conveying device provided in a machine tool according to the invention is designed so that it conveys the workpieces over a predetermined conveying section from one take-over position to another take-over position. Ideally the conveying device is able in this connection to change the conveying direction. Such transporting devices are also known in the specialist language as “shuttle devices”. They enable the workpieces being transported in each case to be conveyed in a direct path through the machine tool from one take-over position to the other take-over position and without the need for complicated resetting operations. The conveying device can for this purpose be designed in a known manner as an electrically, pneumatically or hydraulically driven linear conveyor. Alternatively the conveying device can also be designed as an endless conveyor belt or endless conveyor chain, whose conveying direction can be quickly changed by using corresponding drive mechanisms.

An optimally simple arrangement of a conveying device provided in a machine tool according to the invention is achieved if the conveying device transports workpieces allocated to it linearly, i.e. along a straight line, from a take-over position arranged on one side of the machining cell to a take-over position arranged on the opposite side of the machining cell. However, all other configurations of transporting pathways are also conceivable. Thus, for example, it may be convenient in the case of machine tools arranged diagonally to guide the workpieces from one machine tool by means of their conveying device via a conveying section to the next machine tool, which runs in a correspondingly curved path.

The conveying device provided according to the invention can be coupled as an add-on part to the machine housing. A particularly compact, space-saving variant of the invention is then obtained if the conveying section of the conveying device is guided within the cube-shaped envelope of the machining cell, in other words is arranged so that it does not increase the basic dimensions of the machine tool according to the invention compared to a conventional machining cell. For this purpose the conveying section of the conveying device can run through the machine bed or the machine frame of the machining cell. The machine bed is understood in this connection to mean the lower section, associated with the floor, of the machining cell of a machine tool according to the invention, which as a rule is formed of solid material, such as cast iron or granite, and on which the upper structure parts, such as for example the guides and the drives for the machining device as well as the chip tray and the structural elements of the machining cell needed for the power supply and control, are mounted. The term “machine frame” means on the other hand the structural parts required to support the machining device and its guides as well as drive mechanisms on the machine bed. “Machine housing” means the housing that as a rule surrounds the machine frame and all functional parts as well as possibly also the machine bed of the machining cell. The cube-shaped “envelope” of the machining cell is the smallest imaginary cube that completely accommodates the machining cell.

The incorporation into a production line, in which the workpiece flow follows a linear conveying direction and in which the machine tools coupled to one another are arranged standing in line, can be simplified if the transfer point and a take-over position of the conveying device are provided jointly on one side of the machining cell. In this arrangement the transfer point and the relevant take-over position are arranged so that by means of a suitable gripping device workpieces to be machined or that are already finish-machined can be moved backwards and forwards in a simple way between the transfer point of the machining cell and the take-over position of the conveying device. This possibility then works out particularly advantageously if the machine tool according to the invention is incorporated in a production line in which the distribution of the workpieces is carried out via a so-called automation cell depending on a predetermined production programme.

Also in relation to the invention there exists an arrangement of the invention that is particularly important in practice, in which a machine tool according to the invention includes an automation cell that is provided to take over, depending on control signals from a control device, workpieces that are in readiness

a) in a workpiece store of the machine tool,
b) at the transfer point of the machining cell of the machine tool,
c) at one of the take-over positions of the conveying device of the machine tool or
d) at another take-over position of the machine tool different from the take-over position of its conveying device,
and to distribute them to the machining device of the machining cell or to the conveying device of the machine tool.

The automation cell provided in the arrangement mentioned above takes over the automatic distribution of the workpieces reaching it, depending on whether the respective workpiece is to undergo a machining or not in the machine tool coupled to it and through which it then travels. The automation cell is for this purpose able to distribute workpieces reaching it corresponding to the respective envisaged production run, to the machining cell assigned to it, to the workpiece store assigned to it, the conveying devices of the respective machine tool assigned to it, or to a further conveying device that is additionally assigned to the automation cell. The first of the aforementioned conveying devices is the conveying device of the machine tool according to the invention, to which also the respective automation cell belongs. The second assigned conveying device can be the conveying device of a second machine tool designed in the manner according to the invention, in which the workpieces are subjected to an upstream or downstream machining or through which the workpieces are in each case only conveyed, without being machined.

With the automation cell of a machine tool according to the invention therefore
workpieces that are held in a workpiece store can be fed into the production run, in which via the automation cell the relevant workpieces are distributed to the machining cell or to the conveying device of the respective machine tool or to the conveying device of the second machine tool also coupled according to the invention to the respective automation cell,
workpieces that pass from the conveying device of the second machine tool according to the invention to their take-over position allocated to the respective automation cell are distributed to the machining cell or to the conveying section of the machine tool to which also the automation cell belongs,
   or
workpieces that are finish-machined are taken from the production run, in which the automation cell deposits the workpieces in the workpiece store assigned to it.

A production line that comprises at least two machine tools including in the manner according to the invention a machining cell, a conveying device and an automation cell, therefore allows in an optimally flexible manner the operation according to the following process steps:
taking over a workpiece that is in readiness in the workpiece store of one of the machine tools, at the transfer position of the machining cell of the relevant machine tool, at the take-over position of the conveying device of the relevant machine tool associated with the automation cell of the relevant machine tool, or at the take-over position, associated with the respective machine tool, of the conveying device of that machine tool that is arranged immediately adjacent to the automation cell of the relevant machine tool,
   and
distributing the workpiece taken over in each case from the automation cell to the machining device of the machining cell of the relevant machine tool, to the conveying device of the relevant machine tool, to the workpiece store of the relevant machine tool, or to the conveying device of that machine tool that is arranged immediately adjacent to the automation cell of the relevant machine tool.

In order to ensure an optimum modularity, the automation cell that is made available to the machining cell of the respective machine tool according to the invention can form a structurally independent unit and can be detachably connected to the machining cell. This enables the automation cell to be removed from the machining cell for purposes of maintenance or repair, without the need for complicated restructuring work.

Obviously this possibility does not exclude integrating the function of the automation cell as an alternative into the machine tool.

In the case where the transfer point of the machining cell and the take-over position of the conveying device assigned to it are arranged jointly on one side of the machining cell, this results in a particularly compact and optimised arrangement of a machine tool according to the invention in terms of the movement sequence of the automation cell, in that the automation cell is coupled to the side of the machining cell provided with the transfer point of the machining cell and the take-over position of the conveying device.

In order to be able to undertake the distribution of the workpieces in the respectively predetermined manner, the automation cell can include a gripping device designed in the manner of a robot arm, for taking and distributing the respectively available workpiece, the device being driven by a motor and being freely adjustable in at least two degrees of freedom depending on control signals of a control device.

Conventional container systems, such as stacked baskets or pallets, can serve as workpiece store of a machine tool according to the invention, in which the workpieces to be machined are for example pre-sorted in readiness or are placed in an ordered sequence. In this connection the containers can be brought manually or automatically to the respective transfer position. Also, a conventional workpiece conveyor independent of the machine tool according to the invention can serve as workpiece store, which in a relatively large production plant supplies the individual machine tools or production lines coupled there to one another with workpieces in a continuous run.

In principle all machining operations of workpieces that are normally carried out in machining centres or individual machining units can be carried out in a machine tool according to the invention. Typically in this case the machining device of a machine tool according to the invention is provided for a metal-cutting machining of the workpiece respectively positioned in its operating range.

A space-saving and at the same time simple possibility of transferring workpieces to the machining cell of a machine tool according to the invention is provided if the transfer point of the machining cell is formed at a transfer element of a transfer device that can swivel about an axis. The times and movements necessary for the transfer procedure can in this connection be minimised if two transfer locations arranged spaced from one another at a certain angular distance about their swivel axis are formed at the transfer element, from which locations are assigned respectively a workpiece that is to be newly machined by the machining device and another workpiece that is finish-machined by the machining device. The transfer point at which the workpiece to be machined in the respective machining cell is taken over and the workpiece finish machined there is transferred can be provided in a simple manner with a transfer device formed in this way, at a position upstream of the respectively associated side wall of the machining cell that is ideally accessible to an automatic distribution device, in particular the gripper of an automation cell formed in the manner according to the invention.

The invention is described in more detail hereinafter with the aid of exemplary embodiments and with the aid of the drawings, which show in each case schematically:

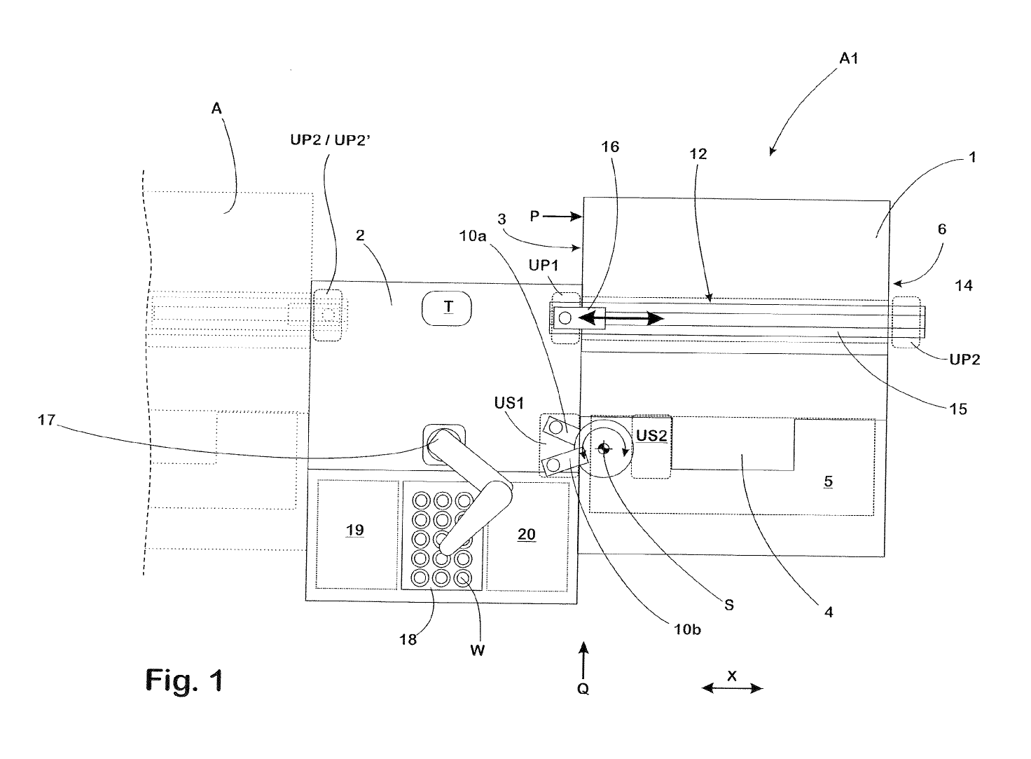

FIG. 1 a machine tool in a longitudinal section from above;

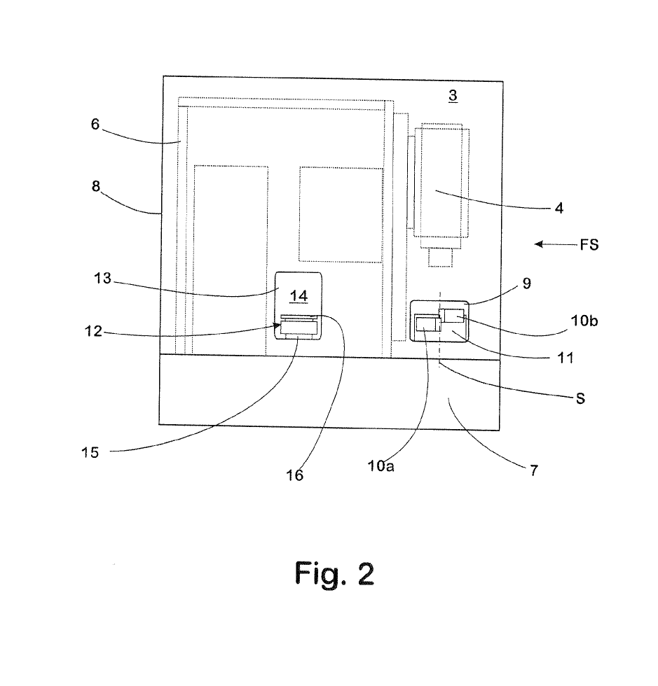

FIG. 2 the machining cell of the machine tool according to FIG. 1 in a side view corresponding to the arrow P indicated in FIG. 1;

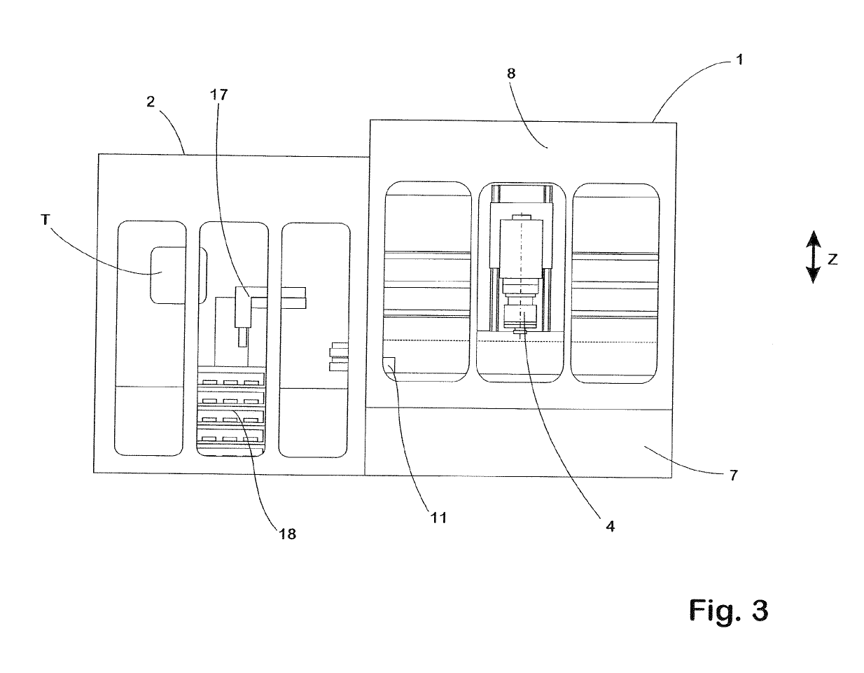

FIG. 3 the machine tool according to FIG. 1 in a front view corresponding to the arrow Q shown in FIG. 1;

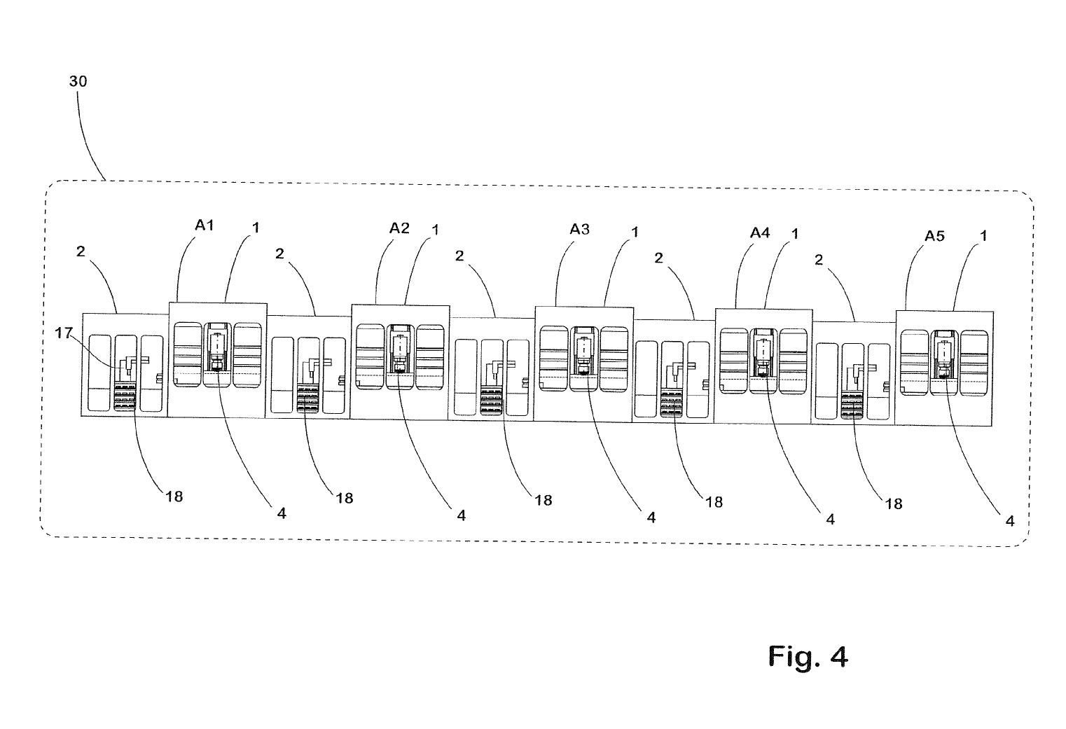

FIG. 4 a production line in a front view corresponding to FIG. 3;

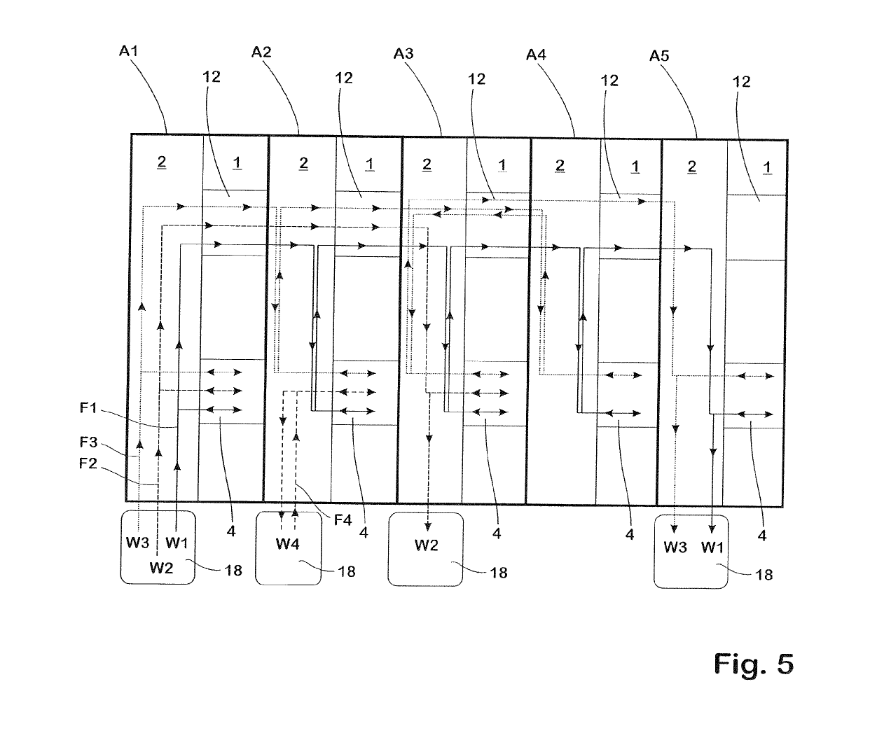

FIG. 5 a diagram of the machining runs of different workpieces machined in the production line according to FIG. 4.

The machine tool A1 shown in FIGS. 1 and 3 comprises a machining cell 1 and an automation cell 2, which is coupled to a longitudinal side 3 of the machining cell 1.

A machining device 4 formed in a manner known per se is arranged vertically aligned in the machining cell 1, and is equipped for example for grinding, milling, drilling, turning operations or in some other way for metal-cutting machining of a workpiece W, and can be moved via drives, not shown in detail here, in a manner also known per se within an operating region 5 at least in the horizontal direction Z and vertical direction X.

The guides and drives of the machining cell 1, indicated here only schematically, are supported by means of a machine frame 6 on a machine bed 7, which stands on the floor of the hall in which the machine tool A1 is installed. The machine bed 7 consists in a known manner of granite. The machine frame 6 and all units of the machining cell 1 required for the operation of the machining device 6 are at the same time housed in a cube-shaped or block-shaped machine housing 8, which is supported on the likewise cube-shaped machine bed 7. The outer contour of the machine housing 8 and of the machine bed 7 conforms in this way to the cube-shaped envelope of the machining cell 1.

In the longitudinal wall 3 of the machining cell 1 associated with the automation cell 2 a window 9 is formed in a corner region adjoining the front side FS of the machining cell 1 and the machine bed 7. The transfer elements 10a, 10b of a transfer device 11, which are arranged in the operating region 5 of the machining cell 1 and which are formed as swivel arms, engage in a gripping manner through this window 9. The transfer elements 10a, 10b comprise respectively at their free end sections a receptacle for the workpieces W to be machined by the machining device 4 or for the workpieces W finish-machined by the machining device 4. In this connection the transfer elements 10a, 10b can swivel about a common vertically aligned swivel axis S by means of swivel drive from a first transfer point US1, in which they respectively penetrate with their receptacles through the window 9 in the direction of the automation cell 2, to a second transfer point US2, in which they are arranged in the operating region 5 so that the machining device 4 reaches its respective receptacle and from there can take over a workpiece W to be machined or can deposit there a finish-machined workpiece W. In this connection the transfer elements 10a, 10b are arranged and can swivel so that for example in the receptacle of one transfer element 10a a workpiece W to be newly machined is transported to the machining device 4, and the workpiece W that is respectively finish-machined by the machining device 4 can be deposited by the device in the receptacle of the second transfer element 10b.

In addition the machining cell 1 includes as an integral component a conveying device 12 formed in the manner of a shuttle conveyor, which in the rear region of the machine tool A1 is guided within the machine housing 8 through the machine frame 6. Alternatively the conveying device 12 can for example also be guided through the machine bed 7.

The conveying device 12 includes in this connection a conveying section 14 guided in the manner of a tunnel through the machine housing 8 and terminating in a second window 13 formed in the longitudinal side 3, through which an electrically driven carriage 16 can be driven backwards and forwards on a linear guide 15 between a first take-over position UP1, which is located in front of the window 14, bypassing the operating region 5 of the machine device 1, linearly to a second take-over position UP2, which is arranged in front of a window formed, corresponding to the window 14, in the longitudinal wall 16 of the machine housing 8 opposite the longitudinal wall 3.

The automation cell 2 includes a gripping device 17 formed in the manner of a conventional four-axis robot, which is controlled by a control T and can take up or transfer workpieces W at least four different transfer points.

The first of these transfer points is the transfer point US1, at which the transfer elements 10, 11 of the transfer device 12 accept workpieces W to be machined or hold finish-machined workpieces W in readiness.

The second transfer point is the take-over position UP1, at which the conveying device 12 with its carriage 16 can take over a workpiece to be transported from the machine tool A1 or can transfer a workpiece W to be machined in the machine tool A1.

The third take-over point is a workpiece store 18, which in the case of the machine tool 1 illustrated in FIGS. 1 to 3 is located at its front side FS. The workpiece store 18 is formed in a manner known per se by baskets stacked above one another, in which the workpieces W to be machined are pre-sorted so that the gripping device 17 can take them without any problem and can also deposit finish-machined workpieces W there without any problem. When all baskets of the workpiece store 1 are emptied or filled in the intended manner, an appropriately prepared workpiece store is moved up to the position of the hitherto worked workpiece store 18. This can take place manually or automatically. A minimum time requirement for the exchange of the workpiece stores can be achieved in this connection if a further workpiece store that can be displaced by simple movement to the position of the hitherto worked workpiece store 18 is in readiness at one of the waiting positions 19,20 provided laterally of the workpiece store 18.

The fourth take-over point is formed by the other take-over position UP2′ associated with the machine tool A1, arranged in the region of the longitudinal side 3′ of the automation cell 2 lying opposite to the longitudinal side and opposite to the take-over position UP1, at which the conveying device of a machine tool A lying opposite the automation cell 2 and coupled to the machining cell 1 can take over or transfer workpieces W.

The production line 30 illustrated in FIG. 4 comprises five machine tools A1-A5. The machine tools A1-A5 are in each case constructed like the machine tool A1. Each machining device 4 of the machine tools A1-A5 however also carries out another machining operation on the workpieces W reaching it. The machine tools A1-A5 stand close next to one another. In other words, the machine tool A1 lies with its longitudinal side 3′ facing away from its automation cell 2 close to the automation cell 2 of the machine tool A2 standing next to it, the automation cell 2 of the machine tool A3 standing next to it stands close to the longitudinal side 3′ of the machine tool A2 facing away from its automation cell 2, and so on. In this way workpieces W can be transported from the conveying devices 12 of the machine tools A1-A5 between respectively adjacent machine tools A1-A5 without interposing additional transporting means.

Various production runs F1-F4 are illustrated in FIG. 5, which can be performed in the production line 30 without having to carry out alteration work on the production line 30.

For the production run F1 in each case a workpiece W1, which is typically a gear tooth wheel, is removed from the workpiece store 18 by the gripping device of the automation cell 2 and transferred at the transfer point US1 by means of the transfer device 11 to the machining device 4. This carries out next a first metal-cutting machining operation on the workpiece W1 and then returns the machined workpiece W1 to the transfer device 11. This then moves the workpiece W1 on to the transfer point US1, from which the gripping device of the automation cell 2 takes over the workpiece and transfers it to the carriage 16 of the conveying device 12, which is waiting at the take-over position UP1.

Following this the conveying device 12 of the machine tool A1 moves the respective workpiece W1 to its take-over position UP2, which is already located in the region of the automation cell 2 of the second machine tool A2 of the product line 30 standing close against the machine tool A1. From the point of view of the second machine tool A2 the take-over position UP2 of the first machine tool A1 is the other take-over position UP2′ different from the take-over positions UP1, UP2 of the second machine tool A2.

In the machine tool A2 the gripping device of the automation cell 2 takes over the workpiece W1 that has reached the take-over position UP2/UP2′ and transfers it at the transfer point US1 of the transfer device 11. This swivels the workpiece W1 into the operating region 5 of the machining device 4, which then carries out a second metal-cutting machining on the workpiece W1. After completion of this machining the workpiece W1 is moved back again to the transfer point US1 and from there is transported by the gripping device to the carriage 16 of the conveying device 12 of the machine tool A2 waiting at the take-over position UP1. The conveying device 12 then moves the workpiece W1 to its second take-over position UP2/UP2′ already located in the region of the third machine tool A3.

In the machine tools A3-A5 subsequently traversed by the workpiece W1, the workpiece is then moved successively in turn in each case in the manner described for the machine tool A2, until the machining in the machine tool A5 has been completed and the workpiece W1 has been moved by the transfer device 11 of the last traversed machine tool A5 back to its transfer position UP1. From there the gripping device of the machine tool A5 takes over the now finish-machined workpiece W1, but however does not pass it on further to the conveying device 12 of the machine tool A5, but instead deposits it in the workpiece store 18.

In the production run F2 a workpiece W2 runs through the machine tool A1 in the manner described hereinbefore for the workpiece W1, until it reaches the take-over position UP2 of the machine tool A1 (take-over position UP2′ of the machine tool A2). From there the gripping device of the machine tool A2 takes it and places it immediately on the carriage 16 of the conveying device 12 of the machine tool A2 waiting at the take-over position UP1. The conveying device 12 transports the workpiece W2 directly to the machine tool A3, so that it is not machined in the machine tool A2. In the machine tool A3 the workpiece W1 is machined in the manner described hereinbefore for the machining of the workpiece W1 in the machine tool A5, and is deposited in the workpiece store 18 of the machine tool A3. A machining of the workpiece W2 in the machine tools A4 and A5 accordingly also does not take place. In the production run F2 the workpiece W2 is therefore only machined in the machine tools A1 and A3, without the need to change the setting of the machine tools A1-A5 or change the machining cycle.

The workpiece W3 is machined and moved in the machine tools A1 and A2 in the manner described for the workpiece W1, until it reaches the take-over position UP2′ of the machine tool A3 (=take-over position UP2 of the machine tool A2). The gripping device of the machine tool A3 takes over the workpiece W3 and passes it on directly to the conveying device 12 of the machine tool A3, which conveys it to the next machine tool A4. There the workpiece W4 is taken over by the respective gripping device and is passed in the aforedescribed manner to the machining device 4 of the machine tool A4. After the metal-cutting machining performed there has been completed, the workpiece W3 is taken from the carriage 16 of the conveying device 12 of the machine tool A3 waiting at the take-over position UP2′ of the machine tool A4 (=take-over position UP2 of the machine tool A3) and is conveyed back to the take-over position UP1 of the machine tool A3. In the machine tool A3 the gripping device thereupon takes over the workpiece W3 from the conveying device 12 and transfers it in the manner explained hereinbefore to the machining device 4. After the machining has finished there, the gripping device takes over the workpiece W3 at the transfer point US3 again and places it on the carriage of the conveying device 12 waiting at the take-over position UP1. The conveying device then moves the workpiece 3 thereby machined in the machine tool A3 to the take-over position UP2 arranged in the machine tool A4 (=take-over position UP2′ of the machine tool A4). From there the workpiece W3 is moved in the manner already described directly to the take-over position UP1 of the conveying device 12 of the machine tool A4. This thereupon conveys the workpiece 3 directly to the machine tool A5, where it is moved and machined in the manner already described for the workpiece W1, until it is deposited in the workpiece store 18 of the machine tool W5. In the production run F3 the workpiece W3 thus passes through the machine tools A1-A5 in the order A1-A2-A4-A3-A4-A5, without any change in the setting of the machine tool A1-A5 being required for this purpose.

In the production run F4 the workpiece W2 to be machined is removed by the gripping device of the machine tool A2 from its workpiece store 18, transferred in the afore-described manner to the machining device of the machine tool A2, where it undergoes metal-cutting machining and after completion of the machining is returned directly to the workpiece store 18. The workpiece W4 is thus machined only in the machine tool A2. This can be advantageous for increasing the degree of utilisation if—as for example in the case of the production run F2—the machine tool A2 is not used on account of the process sequence prescribed there.

If a machine tool A1-A5 has to be replaced for maintenance or repair, then the respective machine tool can be withdrawn as a structural unit from the production line 30 and replaced by a structurally identical machine tool, without having to carry out special reconstruction and dismantling work for this purpose.

### LIST OF REFERENCE NUMERALS

1 Respective machining cell of the machine tools A1-A5
2 Respective automation cell of the machine tools A1-A5
3, 3′ Longitudinal sides of the respective machining cell 1
4 Machining device of the respective machining cell 1
5 Operating region of the respective machining device 4
6 Machine frame of the respective machine tool A1-A5
7 Machine bed of the respective machine tool A1-A5
8 Machine housing of the respective machine tool A1-A5
9 Window
10a, 10b Transfer elements of the transfer device 11
11 Transfer device
12 Conveying device
13 Window
14 Conveying section of the conveying device 12
15 Linear guide of the conveying device 12
16 Carriage of the conveying device 12
17 Gripping device
18 Workpiece store
19, 20 Waiting positions
A, A1-A5 Machine tools
F1-F4 Production runs
FS Front side of the respective machine tool A1-A5
UP1, UP2 Take-over positions of the conveying device 12
UP2′ Take-over position of another conveying device 12
S Swivel axis
T Control
US1, US2 Transfer points
W, W1-W5 Workpieces
X, Z Movement directions of the machining device 4

1. A machine tool for machining a workpiece, said machine tool comprising a machining cell with a machining device for machining the respective workpiece and a transfer point for transferring a workpiece to be machined to the machining device or for outputting a finish-machined workpiece from the machining device, wherein the machine tool additionally includes as an integral constituent a conveying device that transports a workpiece transferred to it between at least two take-over positions, while bypassing the machining device.

2. The machine tool according to claim 1, wherein the conveying device transports workpieces allocated to it linearly from a take-over position arranged on one side of the machining cell to a take-over position arranged on the opposite side of the machining cell.

3. The machine tool according to claim 1, wherein the conveying device runs through a cube-shaped envelope of the machining cell.

4. The machine tool according to claim 1, wherein the conveying device runs through the machine bed of the machining cell.

5. The machine tool according to claim 1, wherein the transfer point and a take-over position of the conveying device are provided jointly on one side of the machining cell.

6. The machine tool according to claim 1, further including an automation cell that takes over, depending on control signals of a control device, workpieces that are provided in readiness in a workpiece store of the machine tool, at the transfer point of the machining cell of the machine tool, at one of the take-over positions of the conveying device of the machine tool or at another take-over position of the machine tool different from the take-over positions of its conveying device, and distributes them to the machining device of the machining cell or to the conveying device of the machine tool.

7. The machine tool according to claim 5, wherein the automation cell is coupled to the side of the machining cell on which are jointly provided the transfer point of the machining cell and said take-over position of the conveying device.

8. The machine tool according to claim 6, wherein the automation cell comprises a gripping device for taking and distributing the respectively ready workpieces, which via a motor drive is freely adjustable in at least two degrees of freedom depending on control signals of a control device.

9. The machine tool according to claim 6, wherein the automation cell forms a structurally independent structural unit, which can be detachably joined to the machining cell.

10. The machine tool according to claim 1, wherein the machining device of the machining cell carries out a metal-cutting machining of the workpiece respectively distributed to it.

11. The machine tool according to claim 1, wherein the transfer point of the machining cell is formed on a transfer element of a transfer device that can swivel about an axis.

12. A production line for the machining of workpieces with at least one machine tool formed according to claim 6.

13. The production line according to claim 12, comprising more than one machine tool formed according to claim 6, wherein the machine tools of the production line carry out different machinings of the workpieces respectively distributed to it.

14. The production line according to claim 13, wherein the machine tools are arranged in succession close to one another in a line.

15. A method for operating a production line formed according to claim 12, comprising the following operating steps:
taking over a workpiece that is in readiness in the workpiece store of one of the machine tools, at the transfer point of the machining cell of the relevant machine tool, at the take-over positions, allocated to the automation cell of the relevant machine tool, of the conveying device of the relevant machine tool, or at the other take-over position, associated with the relevant machine tool, of the conveying device of that machine tool that is arranged immediately next to the automation cell of the relevant machine tool, and
distributing a respectively taken-over workpiece to the machining device of the machining cell of the relevant machine tool, to the conveying device of the relevant machine tool, to the workpiece store of the relevant machine tool, or to the conveying device of that machine tool that is arranged immediately next to the automation cell of the relevant machine tool.
